(19) United States
(12) Patent Application Publication
(10) Pub. No.: US 2016/0135385 A1
(43) Pub. Date: May 19, 2016

(54) SCREEN OF GREEN KIT

(71) Applicant: Meng-Wei Wang, Taichung City (TW)

(72) Inventor: Meng-Wei Wang, Taichung City (TW)

(21) Appl. No.: 14/938,282

(22) Filed: Nov. 11, 2015

(30) Foreign Application Priority Data
Nov. 17, 2014 (TW) 103139807

(51) Int. Cl. A01G 9/12; A01G 17/04

(52) U.S. Cl. CPC A01G 9/12; A01G 17/04

(57) ABSTRACT

A screen of green has a base, a supporting seat, at least one supporting pillar, and a platform. The at least one supporting pillar is erectly mounted on the base. The supporting seat is movably mounted on the at least one supporting pillar and is above the base. The platform has multiple grids and is mounted on the supporting seat. The screen of green kit is utilized to grow a vine and to support the fruit of the vine.

### BACKGROUND OF THE INVENTION

1. Field of the Invention

The present invention relates to a plant growing device, and more particularly to a screen of green kit that can transform a vertical growing profile of a plant into a horizontal growing profile and allow light evenly distributing to every fruit of the plant to increase yield of the plant.

2. Description of Related Art

A vine is a kind of plant that has trailing stems to twist around an erect frame. Some kinds of vines can fruit, such as grapes, passion fruits, loofahs, cucumbers and so on. A plant grower of the vine builds an erect frame or trellis to allow the vines to climb. The frame of trellis are utilized to support the stems and the leaves of the vein and to facilitate the growing of the vine.

However, the conventional trellis is tall and takes a lot of material for manufacturing. Since the conventional trellis is tall, it causes difficulty for the plant grower to reach the fruit of the vine during harvesting and the conventional trellis occupies a lot of space. Most important of all, the conventional trellis allows the vine growing in a vertical profile, the leaves and the fruit of the vine to grow among each other. The leaves block the sunlight and causing unevenly light distribution. The fruit in the upper position absorb adequate sunlight and is bigger than the fruit in the lower position. The size of each fruit varies greatly because each fruit of the vine cannot absorb equal sunlight. Thereby, the conventional trellis cannot guarantee the quality of each fruit.

To overcome the shortcomings of the conventional trellis, the present invention provides a screen of green kit to mitigate or obviate the aforementioned problems.

### SUMMARY OF THE INVENTION

The main objective of the present invention is to provide a screen of green kit capable of supporting fruit, transforming a vertical plant growing profile into a horizontal plant growing profile to let the fruit receive adequate sunlight and increasing yield of agriculture.

The screen of green kit comprises a base, a supporting seat, at least one supporting pillar, and a platform. The at least one supporting pillar is erectly mounted on the base. The supporting seat is movably mounted on the at least one supporting pillar and is above the base. The platform has multiple grids and is mounted on the supporting seat. The screen of green kit is utilized to grow a vine and to support the fruit of the vine. Thereby, each fruit can absorb even sunlight and grow into substantially the same size and ripeness.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a screen of green kit in accordance with the present invention;

FIG. 2A is a partially exploded perspective view of the kit in FIG. 1;

FIG. 2B is an exploded enlarged perspective view of the kit in FIG. 2A;

FIG. 2C is an exploded enlarged perspective view of the kit in FIG. 2A;

FIG. 3 is an operational side view of the kit in FIG. 1;

FIG. 4 is an operational perspective view of the kit in FIG. 1; and

FIG. 5 is an operational perspective view of two kits in FIG. 1, shown assembled together.

### DETAILED DESCRIPTION OF PREFERRED EMBODIMENT

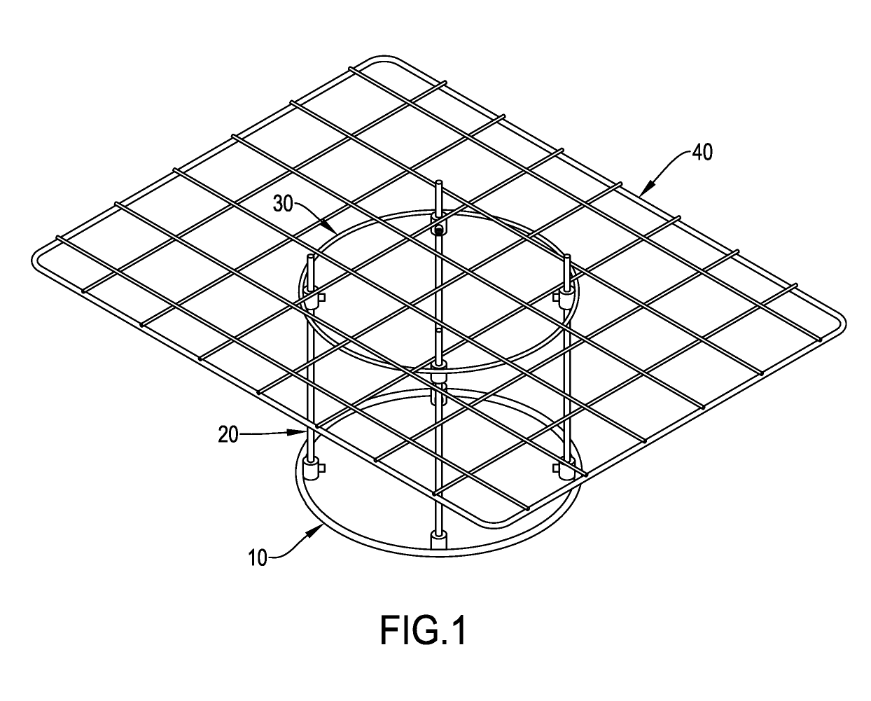

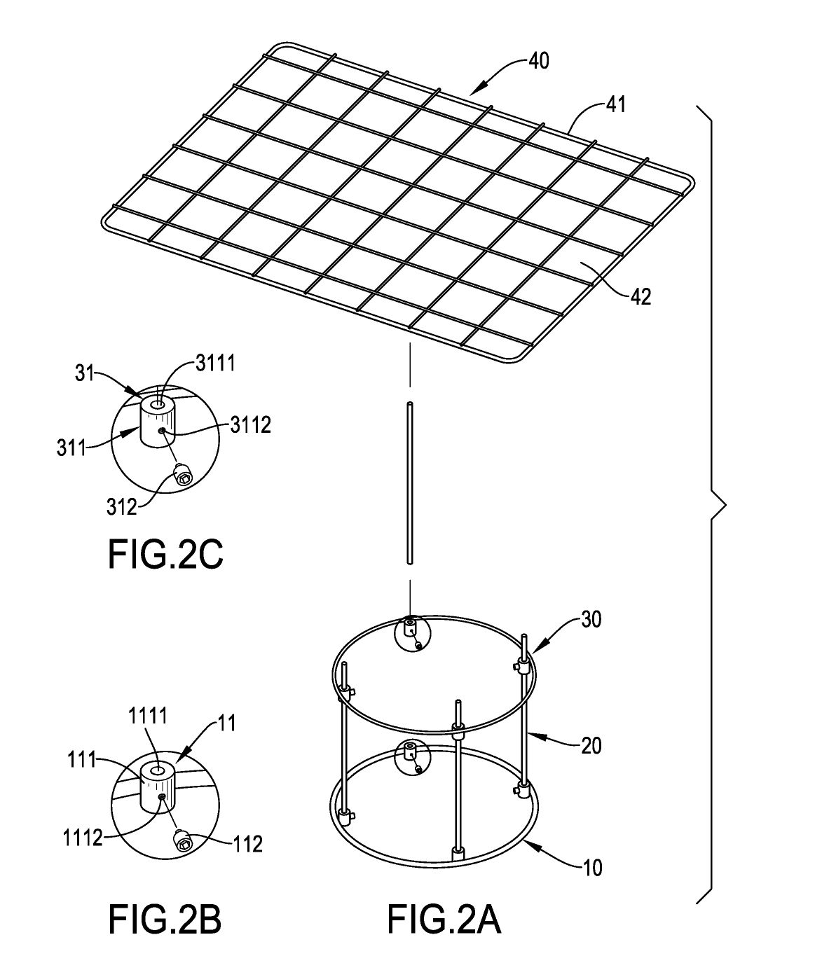

With reference to FIG. 1 and FIG. 2A, a screen of green kit in accordance with the present invention comprises a base 10, at least one supporting pillar 20, a supporting seat 30, and a platform 40.

With reference to FIG. 1, FIG. 2A and FIG. 2B, the base 10 has a loop and at least one fixing structure 11. The at least one fixing structure 11 is implemented as four in amount in the present invention. The four fixing structures 11 are formed on the loop at equiangular intervals. Each fixing structure 11 has a fixing unit 111 and a fixing bolt 112. The fixing unit 111 has a fixing hole 1111, an outer surface, and a fixing threaded hole 1112. The fixing hole 1111 is axially defined in the fixing unit 111. The fixing threaded hole 1112 is radially defined in the outer surface and communicates with the fixing hole 1111, wherein the fixing threaded hole 1112 has an inner surface and a thread formed on the inner surface of the fixing threaded hole 1112. Each fixing bolt 112 is respectively screwed with the fixing threaded hole 1112 of each fixing unit 111.

With reference to FIG. 1 and FIG. 2A, the at least one supporting pillar 20 is erectly mounted on the base 10. The at least one supporting pillar 20 is implemented as four in amount in the present invention. Each supporting pillar 20 has a first end and a second end. The first end and the second end of each supporting pillar 20 are opposite each other. The first end of each supporting pillar 20 is respectively mounted into the fixing hole of each fixing unit 111. Each fixing bolt 112 respectively abuts against each supporting pillar 20.

With reference to FIG. 1, FIG. 2A and FIG. 2C, the supporting seat 30 is movably mounted on the four supporting pillars 20 and is above the base 10. The second end of each supporting pillar 20 extends through the supporting seat 30. The supporting seat 30 has a loop and at least one adjusting structure 31. The at least one adjusting structure 31 is implemented as four in amount in the present invention. The four adjusting structures 31 are formed on the loop of the supporting seat 30 at equiangular intervals. Each fixing structure 31 has an adjusting unit 311 and an adjusting bolt 312. The adjusting unit 311 has an adjusting hole 3111, an outer surface, and an adjusting threaded hole 3112. The adjusting hole 3111 is axially defined through the adjusting unit 311. The adjusting threaded hole 3112 is radially defined in the outer surface of the adjusting unit 311 and communicates with the adjusting hole 3111, wherein the adjusting threaded hole 3112 has an inner surface and a thread formed on the inner surface of the adjusting threaded hole 3112. Each adjusting hole 3111 is respectively disposed around the second end of each supporting pillar 20. Each adjusting bolt 312 is respectively screwed with each adjusting threaded hole 3112 of each adjusting unit 311 and respectively abuts against each supporting pillar 20.

With reference to FIG. 1 and FIG. 2A, the platform 40 is mounted on the supporting seat 30 and has a frame portion 41 and multiple grids 42. Each grid 42 is rectangular in shape. Each grid 42 may be in any polygonal shape. The platform 40 may be detachably placed on the supporting seat 30 or may be securely attached on the supporting seat 30 by welding, tying, or gluing.

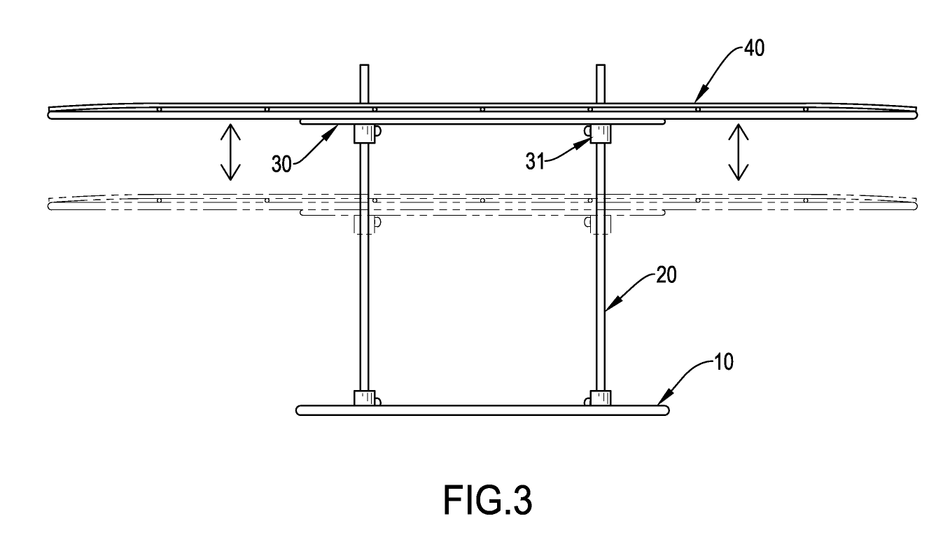

With reference to FIG. 3, the position of the platform 40 may be adjusted by releasing the four adjusting bolts 312, and the supporting seat 30 is moved along the four supporting pillars 20 up and down to a suitable position. Then, the four adjusting bolts 312 are rotated to abut against the four supporting pillars 20 respectively. The adjustable platform 40 can keep the height of a plant under a suitable altitude for reaching and harvesting.

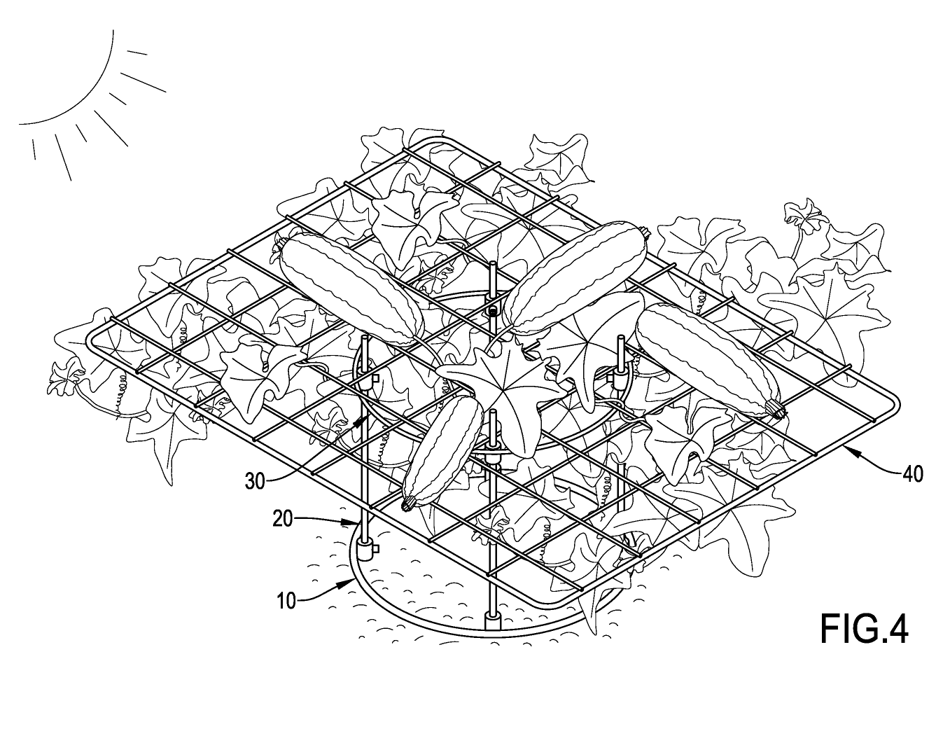

With reference to FIG. 4, the stems of a plant can climb along the supporting pillars 20 and then twist around the supporting seat 30 and the platform 40. As a vine is growing, a plant grower may gradually move the stems and the leaves of the vine beneath the platform 40, and may move the fruit of the vine above the platform 40 to absorb even quantity of sunlight. Accordingly, each fruit can grow into substantially the same size and ripeness. The screen of green kit in accordance with the present invention occupies less space, is easy for harvesting and management, and saves a lot of energy and time on plant growing.

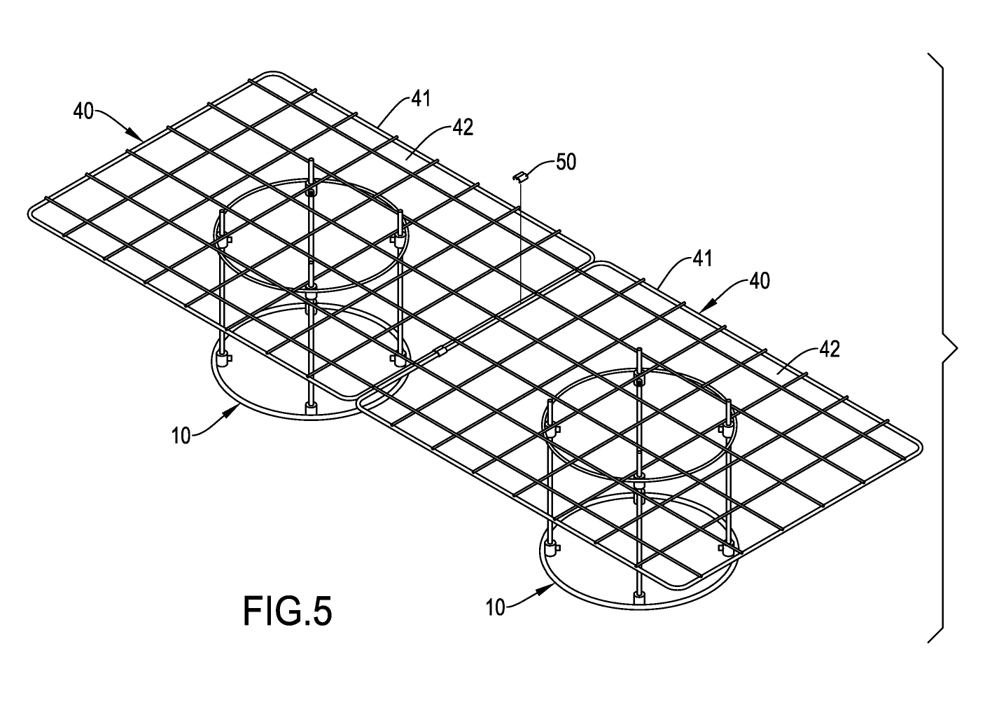

With reference to FIG. 5, the screen of green kit in accordance with the present invention may further comprise a clasp 50 to clasp the frame portion 41 of the platform 40 of another kit. The two kits are arranged side by side. The two frame portions 41 of the two platforms 40 abut against each other. The clasp 50 clasps the two frame portions 41 of the two platforms 40 to assemble the two kits and expand an area of the platforms 40 to fit with the growth of a plant. The platforms 40 can be aligned and attached to each other to create larger horizontal growing area and is easy to execute irrigation, pest control and fertilization.

The screen of green kit in accordance with the present invention may be utilized on balconies, yards, Indoor gardens, industrial size cultivation, or so on. These kits may be flexibly arranged in a pattern of cross-shape or in T-shape and be fastened by the clasp 50 to fit with different plant growing fields.

The screen of green kit provides low stress training for the plant and transforms a vertical plant growing profile into a horizontal plant growing profile. That is, the screen of green kit makes a plant grow laterally and provides support for the fruits to allow the sunlight evenly distributing to every fruit of the plant and increases the yield of the plant.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A screen of green kit comprising:
a base;
at least one supporting pillar erectly mounted on the base;
a supporting seat movably mounted on the at least one supporting pillar and being above the base; and
a platform mounted on the supporting seat and having multiple grids.

2. The screen of green kit as claimed in claim 1, wherein
the supporting seat has at least one adjusting structure connected respectively with the at least one supporting pillar, and each one of the at least one adjusting structure has
an adjusting unit having
a through hole axially defined through the adjusting unit and mounted around a corresponding one of the at least one supporting pillar; and
an outer surface;
an adjusting threaded hole radially defined in the outer surface of the adjusting unit and communicating with the through hole; and
an adjusting bolt screwed with the adjusting threaded hole and abutting against the corresponding supporting pillar.

3. The screen of green kit as claimed in claim 2, wherein
the base has at least one fixing structure connected respectively with the corresponding supporting pillar, and each one of the at least one fixing structure has
a fixing unit having
a fixing hole axially defined in the fixing unit and disposed around the corresponding supporting pillar;
an outer surface; and
a fixing threaded hole radially defined in the outer surface of the fixing unit and communicating with the fixing hole; and
a fixing bolt screwed with the fixing threaded hole and abutting against the corresponding supporting pillar.

4. The screen of green kit as claimed in claim 3, wherein
the at least one fixing structure is implemented as four in amount;
the at least one adjusting structure is implemented as four in amount; and
the at least one supporting pillar is implemented as four in amount.

5. The screen of green kit as claimed in claim 4, wherein the platform is welded on the supporting seat.

6. The screen of green kit as claimed in claim 1 further comprising a clasp mounted on a frame portion of the platform to clasp the frame portion of the platform of another screen of green kit.

7. The screen of green kit as claimed in claim 2 further comprising a clasp mounted on a frame portion of the platform to clasp the frame portion of the platform of another screen of green kit.

8. The screen of green kit as claimed in claim 3 further comprising a clasp mounted on a frame portion of the platform to clasp the frame portion of the platform of another screen of green kit.

9. The screen of green kit as claimed in claim 4 further comprising a clasp mounted on a frame portion of the platform to clasp the frame portion of another screen of green kit.

10. The screen of green kit as claimed in claim 5 further comprising a clasp mounted on a frame portion of the platform to clasp the frame portion of the platform of another screen of green kit.
